(19) United States
(12) Patent Application Publication
(10) Pub. No.: US 2026/0031636 A1
(43) Pub. Date: Jan. 29, 2026

(54) BATTERY PACK CONTROL METHOD, ENERGY STORAGE DEVICE AND SYSTEM, AND STORAGE MEDIUM

(71) Applicant: ECOFLOW INC., Shenzhen (CN)

(72) Inventors: Juntong CHEN, Shenzhen (CN); Dong WU, Shenzhen (CN); Xi CHEN, Shenzhen (CN); Lei WANG, Shenzhen (CN)

(21) Appl. No.: 19/341,943

(22) Filed: Sep. 26, 2025

Related U.S. Application Data
(63) Continuation of application No. PCT/CN2024/082550, filed on Mar. 20, 2024.

(30) Foreign Application Priority Data
Mar. 31, 2023 (CN) 202310369395.1

(51) Int. Cl. H02J 7/00; H01M 10/44

(52) U.S. Cl. CPC H02J 7/0031; H01M 10/441; H01M 10/448; H02J 7/0048; H02J 7/0063; H02J 7/00712

(57) ABSTRACT

A battery pack control method includes: detecting real-time load power of a multi-battery pack system; and when the real-time load power is less than a first power threshold, and at least two battery packs discharge in parallel, determining a target battery pack from the battery packs discharging in parallel, maintaining a discharge function of the target battery pack, and disabling a discharge function of another battery pack discharging in parallel other than the target battery pack.

### CROSS-REFERENCE TO RELATED APPLICATIONS

This application is a continuation application of PCT patent application No. PCT/CN2024/082550, filed on Mar. 20, 2024, which claims priority to Chinese Patent Application No. 2023103693951, filed on Mar. 31, 2023, all of which is incorporated herein by reference in their entirety.

### TECHNICAL FIELD

The present application relates to the technical field of energy storage devices, and in particular, to a battery pack control method, an energy storage device and system, and a computer-readable storage medium.

### BACKGROUND

The statements herein merely provide background information related to the present application, and may not necessarily constitute an example technology.

In a scenario in which a plurality of battery packs operate in parallel, if there is a voltage difference between the battery packs, a circulating current may be generated between the battery packs. When the plurality of battery packs are connected to low load power, a large circulating current may be generated. The large circulating current may cause a high current, resulting in an overload of the battery packs. Consequently, normal operation of the battery packs may be affected, and even the battery packs are damaged. Therefore, how to avoid the large circulating current damaging the battery pack becomes an urgent technical problem that needs to be solved currently.

### SUMMARY

According to various embodiments of the present application, a battery pack control method, an energy storage device and system, and a computer-readable storage medium are provided.

One embodiment of the present application provides a battery pack control method for controlling a plurality of battery packs in a multi-battery pack system. The method includes:
detecting real-time load power of the multi-battery pack system; and
when the real-time load power is less than a first power threshold, and at least two battery packs discharge in parallel, determining a target battery pack from the battery packs discharging in parallel, maintaining a discharge function of the target battery pack, and disabling a discharge function of another battery pack discharging in parallel other than the target battery pack.

One embodiment of the present application further provides an energy storage device. The energy storage device includes a battery pack, a processor, a memory, a computer program stored on the memory and executable by the processor, and a data bus configured to implement a connection and communication between the processor and the memory. When the computer program is executed by the processor, the foregoing battery pack control method is implemented.

One embodiment of the present application further provides an energy storage system. The energy storage system includes a controller and a plurality of battery packs. The controller is communicatively connected to the plurality of battery packs. The controller is configured to perform the foregoing battery pack control method.

One embodiment of the present application further provides a storage medium for computer-readable storage. The storage medium stores one or more programs. The one or more programs are executable by one or more processors, to implement the foregoing battery pack control method.

Details of one or more embodiments of the present application will be proposed in the following drawings and descriptions. Other features, objectives, and advantages of the present application will become apparent in the specification, the drawings, and the claims.

### BRIEF DESCRIPTION OF THE DRAWINGS

To describe the technical solutions in embodiments of the present application more clearly, the following briefly describes the accompanying drawings required for describing the embodiments. It is clear that the accompanying drawings in the following descriptions show some embodiments of the present application, and a person of ordinary skill in the art may still derive other drawings from these accompanying drawings without creative efforts.

FIG. 1 is a schematic flowchart of a first embodiment of a battery pack control method according to one embodiment of the present application;

FIG. 2 is a schematic flowchart of a second embodiment of a battery pack control method according to one embodiment of the present application;

FIG. 3 is a schematic flowchart of a third embodiment of a battery pack control method according to one embodiment of the present application;

FIG. 4 is a schematic block diagram of an energy storage system according to one embodiment of the present application; and

FIG. 5 is a schematic block diagram of a structure of an energy storage device according to one embodiment of the present application.

Implementation of the objectives, functional characteristics, and advantages of the present application will be further described with reference to the embodiments and the accompanying drawings.

### DETAILED DESCRIPTION

The following clearly and completely describes the technical solutions in the embodiments of the present application with reference to the accompanying drawings in the embodiments of the present application. Apparently, the described embodiments are a part but not all of the embodiments of the present application. All other embodiments obtained by a person of ordinary skill in the art based on the embodiments of the present application without creative efforts shall fall within the protection scope of the present application.

The flowcharts shown in the accompanying drawings are merely exemplary descriptions, do not need to include all content and operations/steps, and do not need to be performed in the described orders either. For example, some operations/steps may be further divided, combined, or partially combined. Therefore, an actual execution order may change based on an actual situation.

The following describes in detail some implementations of the present application with reference to the accompanying drawings. In absence of conflicts, the following embodiments and features in the embodiments may be combined.

Currently, when a plurality of battery packs in a parallel circuit of an energy storage device operate in parallel, a circulating current may be generated by a voltage deviation. When the plurality of battery packs are connected to low load power, a large circulating current may be generated. When the circulating current reaches a specific level, the battery packs may be overloaded, and a power supply may be damaged.

To solve the foregoing problem, the embodiments of the present application provide a battery pack control method, an energy storage device and system, and a computer-readable storage medium. Real-time load power of a multi-battery pack system is detected. When it is detected that the real-time load power of the multi-battery pack system is less than a first power threshold, and at least two battery packs discharge in parallel, a target battery pack is selected from the battery packs discharging in parallel, and a discharge function of another parallel battery pack other than the target battery pack is disabled. According to the method, parallel operations of the plurality of battery packs under low real-time load power can be avoided, so that generation of a large circulating current is avoided, and the battery packs are protected.

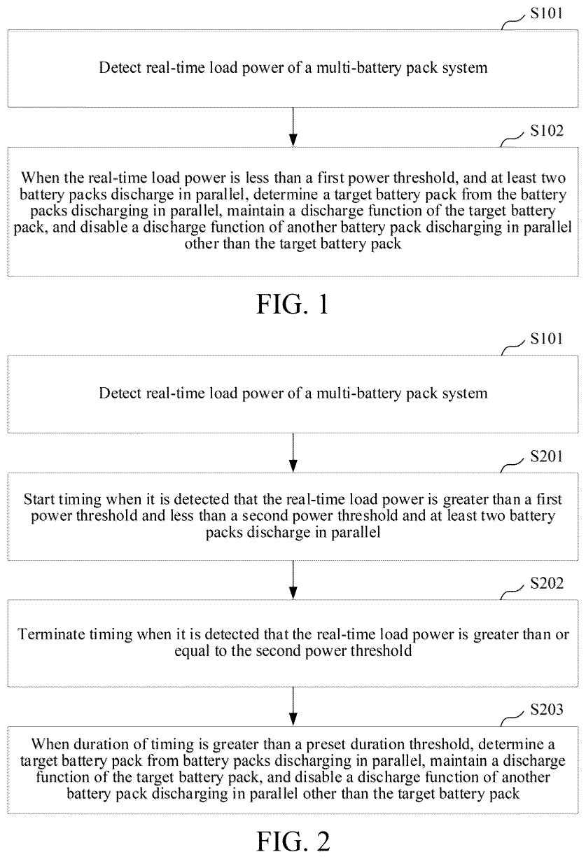

Refer to FIG. 1. FIG. 1 is a schematic flowchart of a first embodiment of a battery pack control method according to an embodiment of the present application.

As shown in FIG. 1, the battery pack control method includes step S101 and step S102.
Step S101: Detect real-time load power of a multi-battery pack system.

In this embodiment, the multi-battery pack system includes a plurality of battery packs, and the plurality of battery packs may be connected together in a parallel operation manner (that is, in parallel) to form the multi-battery pack system. When the multi-battery pack system supplies power to a load, real-time load power of a load circuit is detected in real time via a power detection apparatus, to achieve a purpose of monitoring the multi-battery pack system in real time and prepare for subsequently determining whether there is a parallel no-load operation of the battery packs.

For example, the battery pack may be an apparatus or device capable of storing and supplying energy, such as a battery module or a mobile energy storage.

In an embodiment, the detecting real-time load power of a multi-battery pack system includes: detecting real-time load power of each battery pack; and determining the real-time load power of the multi-battery pack system based on the real-time load power of each battery pack.

In an embodiment, the real-time load power of each battery pack in the multi-battery pack system discharging in parallel is detected via the power detection apparatus, and a sum of the real-time load power of each parallel battery pack is the real-time load power of the multi-battery pack system. In this embodiment, the real-time load power of each battery pack is detected, and the real-time load power of the multi-battery pack system is calculated based on the real-time load power of each battery pack. Therefore, the real-time load power of the multi-battery pack system is more accurate, and accuracy of the battery pack control method can be improved.

In an embodiment, the power detection apparatus may be a power meter, a power tester, or another detection apparatus, detection circuit, or the like that can be configured to detect real-time power of the load circuit. This is not limited in this embodiment of the present application.

It may be understood that during the parallel operation of the multi-battery pack system, if load power is low, for example, the load power is zero, the parallel operation of the plurality of battery packs in the multi-battery pack system may cause an overload error of the multi-battery pack system. This is because during the parallel operation of the multi-battery pack system under a no-load condition, even a slight deviation of a voltage for the parallel operation may generate a large circulating current because internal resistance of an electrochemical cell is low. When the circulating current reaches a specific level, the multi-battery pack system may have a current overload due to an excessively high current. During the parallel operation of the multi-battery pack system under a load condition, because a load has specific resistance, a circulating current generated by a voltage deviation is small, so that a parallel operation overload is less likely to occur. Therefore, in the load circuit in which the multi-battery pack system operates in parallel for energy supply, load power of the load circuit needs to be monitored in real time, to avoid the parallel operation overload.

The parallel operation means connecting a plurality of energy storage devices (for example, the plurality of battery packs) in parallel to form a high-capacity power supply for supplying power to the load. The plurality of energy storage devices operate in parallel, and the energy storage devices connected in parallel share the load equally. When one energy storage device cannot operate because of a failure or maintenance, a load provided by the energy storage device is allocated to another energy storage device. Therefore, the parallel operation of the energy storage devices can provide a reliable and stable power supply system.

A circulating current means that when two or more battery packs operate in parallel, because voltages of the battery packs are not completely the same, there is a voltage difference between the plurality of battery packs. Under this voltage difference, a current may be generated inside each battery pack through a loop formed by a winding of each battery pack. This current does not flow into the load to do work, and instead, circulates through armature windings of the plurality of battery packs. Therefore, the current is referred to as a circulating current.

In an embodiment, the circulating current occurs when the plurality of battery packs operate in parallel. When the plurality of battery packs operate in parallel, if output power of the plurality of battery packs is allocated non-uniformly, the circulating current increases. The circulating current can be kept within a controllable range only by adjusting the output power of the plurality of battery packs to be allocated uniformly.

For example, in a system in which two battery packs operate in parallel, if one battery pack is adjusted to increase active power output by the battery pack, there may be an active circulating current in armature windings of the two battery packs. Under an action of the active circulating current, active power output by the unadjusted battery pack decreases, and the active power output by the power generator with an increased input increases. This unbalances the output power of the two battery packs and increases a voltage difference, thereby increasing the circulating current. In this case, the output power of the battery packs needs to be reallocated for a balance, to reduce the circulating current, or one battery pack needs to be turned off to eliminate the circulating current.

In an embodiment, the multi-battery pack system may be centrally dispatched to allocate active loads and reactive loads, so that the multi-battery pack system can be maintained and repaired more conveniently and in time. In addition, the plurality of battery packs in the multi-battery pack system may be flexibly deployed for parallel operation based on different load conditions. For different load energy supply requirements, appropriate numbers of battery packs may be deployed to form parallel systems, to reduce losses of the battery packs.
Step S102: When the real-time load power is less than a first power threshold, and at least two battery packs discharge in parallel, determine a target battery pack from the battery packs discharging in parallel, maintain a discharge function of the target battery pack, and disable a discharge function of another battery pack discharging in parallel other than the target battery pack.

For example, when the real-time load power is less than the first power threshold, and two battery packs discharge in parallel, the battery pack with highest power in the two battery packs may be determined as the target battery pack. In other words, the battery pack with low power is directly turned off, and the other battery pack with high power discharges to supply energy, to prevent a parallel no-load operation exception.

In an embodiment, a number of battery packs that are operating currently may be determined by monitoring an input/output (I/O) signal in the load circuit. One set of I/O signals corresponds to one battery pack. Therefore, a number of I/O signals is the number of battery packs that are operating currently.

In an embodiment, the disabling a discharge function of another battery pack discharging in parallel other than the target battery pack includes: turning off a discharge switching transistor of the another battery pack discharging in parallel other than the target battery pack.

For example, a pulse control signal or a level signal may be output to a control end of the discharge switching transistor of the another battery pack discharging in parallel other than the target battery pack, to control the corresponding discharge switching transistor to be turned off, so that the battery pack other than the target battery pack is in a non-operating state.

For example, the discharge switching transistor may be a gas discharge tube (GDT). The gas discharge tube is a sealed gas discharge component including a metal electrode and a ceramic tube shell, such as a diode and a triode, and is usually for overvoltage protection to ground. Specifically, a small amount of gas (mainly rare gases neon and argon) is sealed inside the discharge switching transistor using a metalized ceramic insulating tube shell and an electric welding technology. A direct current breakdown voltage, an impulse breakdown voltage, a power-frequency current withstanding capability, service life, and the like of the GDT may be changed by changing internal gas pressure, material compositions of an electrode coating, and an electrode spacing.

For example, during the operation of the gas discharge tube, when voltages applied to two ends of the gas discharge tube exceed a breakdown voltage, the gas in the discharge tube is ionized, and the discharge tube starts discharging. The voltages at the two ends of the discharge tube drop quickly to a glow discharge voltage, and a current in the tube starts rising. The current in the tube further increases, and the rare gas inside the discharge tube enters a discharge state. In this case, the voltages at the two ends are quite low. This state may remain for a period of time. When the current flowing through the GDT drops below a voltage for maintaining the discharge state, discharge stops and ends, and the voltage returns to an original value.

In an embodiment, the discharge switching transistor may be a metal oxide semiconductor (MOS) transistor, an insulated gate bipolar transistor (IGBT), or another transistor.

In an embodiment, the determining a target battery pack from the battery packs discharging in parallel includes: obtaining a state of charge of each battery pack discharging in parallel; and determining a battery pack with a highest state of charge as the target battery pack.

In an embodiment, a state of charge of a battery is an available state of a remaining charge in the battery, and is usually represented by a percentage, that is, a ratio of the remaining charge in the battery to a rated charge capacity of the battery.

For example, when the target battery pack needs to be determined from the battery packs discharging in parallel, if each battery pack discharging in parallel has a same charge capacity, the battery pack with the highest state of charge may be selected from the battery packs as the target battery pack. The target battery pack continues to supply power to the load circuit, to ensure continuous operation of the load circuit.

For example, if the battery packs discharging in parallel have different charge capacities, the battery pack with most remaining charges may be selected from the battery packs as the target battery pack.

In an embodiment, the determining a target battery pack from the battery packs that are discharged in parallel includes: obtaining a battery capacity of each battery pack discharging in parallel; and determining a battery pack with a highest battery capacity as the target battery pack.

For example, if the battery packs discharging in parallel have different battery capacities, the battery pack with the highest battery capacity may be selected as the target battery pack, to ensure a higher power withstanding capability and avoid an overloaded operation of a low-capacity battery pack caused by excessively high load power of the load circuit.

The battery pack control method provided in this embodiment of the present application includes: detecting the real-time load power of the multi-battery pack system; and when the real-time load power is less than the first power threshold, and the at least two battery packs discharge in parallel, determining the target battery pack from the battery packs discharging in parallel, maintaining the discharge function of the target battery pack, and disabling the discharge function of the another battery pack discharging in parallel other than the target battery pack. A power change of the load is obtained by detecting the real-time load power of the multi-battery pack system. When it is detected that the real-time load power of the multi-battery pack system is less than the first power threshold, and the at least two battery packs discharge in parallel, to avoid the circulating current damaging the battery pack, the target battery pack is selected from the battery packs discharging in parallel, and the discharge function of the another parallel battery pack other than the target battery pack is disabled. According to the method, a no-load parallel operation of the plurality of battery packs can be avoided, so that generation of a large circulating current is avoided, and the battery packs are protected.

Refer to FIG. 2. FIG. 2 is a schematic flowchart of a second embodiment of a battery pack control method according to an embodiment of the present application.

As shown in FIG. 2, in this embodiment, based on the embodiment shown in FIG. 1, after step S101, the method further specifically includes the following steps.
Step S201: When it is detected that the real-time load power is greater than the first power threshold and less than a second power threshold, and the at least two battery packs discharge in parallel, start timing.
Step S202: When it is detected that the real-time load power is greater than or equal to the second power threshold, terminate timing.

The first power threshold is less than the second power threshold.

In an embodiment, when the load in the load circuit changes, the load power also changes. When the load power changes, whether the load power reaches a stable state needs to be determined, to determine whether the system in which the plurality of battery packs operate in parallel needs to be used to supply power to the load circuit.

In an embodiment, when the at least two battery packs discharge in parallel in the load circuit, timing is started when it is detected that the real-time load power is greater than the first power threshold, and timing is terminated when it is detected that the real-time load power is greater than or equal to the second power threshold. In other words, duration of keeping the real-time load power between the first power threshold and the second power threshold is calculated.

For example, the first power threshold may be set to 400 W, and the second power threshold may be set to 1800 W.
Step S203: When duration of timing is greater than a preset duration threshold, determine the target battery pack from the battery packs discharging in parallel, maintain the discharge function of the target battery pack, and disable the discharge function of the another battery pack discharging in parallel other than the target battery pack.

For example, when the duration of timing is greater than the preset duration threshold, that is, the duration of keeping the real-time load power between the first power threshold and the second power threshold is greater than the preset duration threshold (for example, the preset duration threshold is 1 minute), it may be considered that the real-time load power of the load circuit has currently tended to the stable state. At this point, the real-time load power of the load circuit is kept between the first power threshold and the second power threshold. In this case, the real-time load power does not reach the second power threshold, and parallel discharge of the plurality of battery packs is not needed. Therefore, one target battery pack may be selected from the plurality of battery packs discharging in parallel to continue discharging to supply energy to the load circuit, and the discharge function of the another battery pack is disabled, to reduce a risk of a parallel no-load operation of the plurality of battery packs.

For example, in a timing process for the duration for which the real-time load power is between the first power threshold and the second power threshold, if the duration does not reach the preset duration threshold, and it is detected that the real-time load power is not greater than the first power threshold or not less than the second power threshold, current timing is reset. If it is detected again that the real-time load power is greater than the first power threshold and less than the second power threshold, timing is performed again, where timing duration is not accumulated.

In this embodiment, the real-time load power of the load circuit is detected, and when the real-time load power is greater than the first power threshold, a load condition of the load circuit is determined by timing and monitoring the duration of keeping the real-time load power between the first power threshold and the second power threshold. When the duration of timing is greater than the preset duration threshold, it is determined that the load power of the load circuit is in the stable state. In this case, the discharge function of the battery pack discharging in parallel other than the target battery pack may be selected to be disabled, and only the target battery pack supplies energy. Therefore, the parallel no-load operation of the plurality of battery packs is avoided.

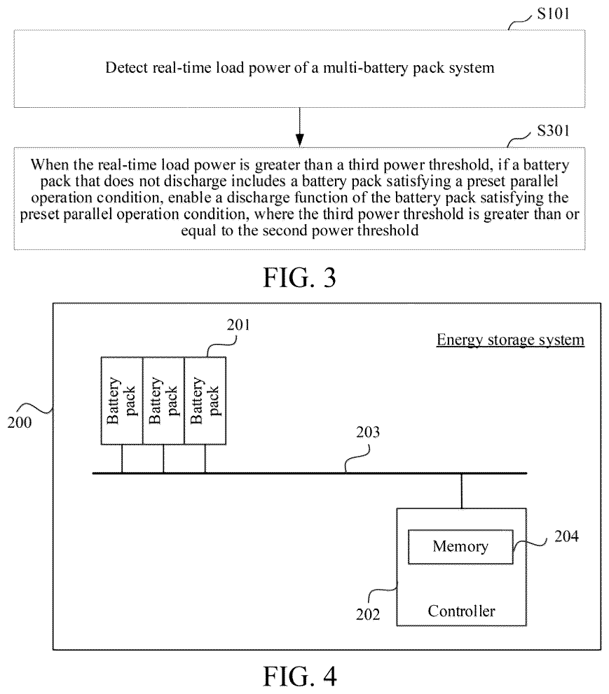

Refer to FIG. 3. FIG. 3 is a schematic flowchart of a third embodiment of a battery pack control method according to an embodiment of the present application.

As shown in FIG. 3, in this embodiment, based on the embodiment shown in FIG. 1, after step S101, the method further specifically includes the following steps.
Step S301: When the real-time load power is greater than a third power threshold, if a battery pack that does not discharge includes a battery pack satisfying a preset parallel operation condition, enable a discharge function of the battery pack satisfying the preset parallel operation condition, where the third power threshold is greater than or equal to a second power threshold.

In an embodiment, when it is detected that the real-time load power of the load circuit is greater than the third power threshold, the real-time load power of the load circuit is high. To ensure a capability of the battery pack in supplying energy for continuous operation, the multi-battery pack system may discharge in parallel to supply energy.

For example, voltages of the battery packs discharging in parallel need to be kept the same, to avoid generation of a large circulating current. Therefore, the battery pack satisfying the preset parallel operation condition may be a battery pack with a same output voltage as a battery pack that is discharging currently, or the battery pack satisfying the preset parallel operation condition may be a battery pack whose voltage difference from a battery pack that is discharging currently is within a specific range. Therefore, when the real-time load power is high, a circulating current generated by a voltage difference within this range is prevented from severely damaging the battery pack because the load has specific internal resistance.

In this embodiment, whether the load power of the load circuit is excessively high is determined by comparing the real-time load power with the third power threshold. When the real-time load power is greater than the third power threshold, the plurality of battery packs discharge in parallel to supply energy to the load circuit, to avoid the battery pack being damaged by overloaded discharge and improve a load carrying capability of the battery pack.

Refer to FIG. 4. FIG. 4 is a schematic block diagram of an energy storage system according to an embodiment of the present application. The energy storage system 200 includes a plurality of battery packs 201 and one or more controllers 202. The one or more controllers 202 operate independently or together. The one or more controllers 202 are configured to implement steps of a battery pack control method.

For example, the battery pack 201 and the controller 202 may be connected through a bus 203.

For example, the controller 202 may be a micro-controller unit (MCU), a central processing unit (CPU), or a digital signal processor (DSP).

For example, the controller 202 may include a memory 204 capable of storing a computer-readable storage medium. The memory 204 may be a flash chip, a read-only memory (ROM), a magnetic disk, an optical disk, a USB drive, a mobile hard disk drive, or the like.

The controller 202 is configured to run a computer program stored in the memory 204, and implement the steps of the battery pack control method when executing the computer program.

It should be noted that a person skilled in the art may clearly understand that, for the purpose of convenient and brief description, for a detailed working process of the foregoing apparatus and each module, refer to a corresponding process in the foregoing battery pack control method embodiments. Details are not described herein again.

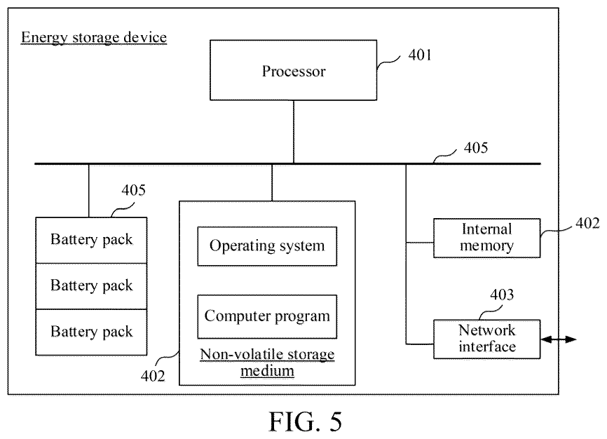

The apparatus provided in the foregoing embodiment may be implemented as a form of a computer program. The computer program may be run on a computer device shown in FIG. 5.

Refer to FIG. 5. FIG. 5 is a schematic block diagram of a structure of an energy storage device according to an embodiment of the present application.

Refer to FIG. 5. The energy storage device includes a processor 401, a memory 402, a network interface 403, and battery packs 404 that are connected through a data bus 405. The memory 402 may include a non-volatile storage medium and an internal memory.

The non-volatile storage medium may store an operating system and a computer program. The computer program includes program instructions. When the program instructions are executed, the processor 401 may be enabled to perform any battery pack control method.

The processor 401 is configured to provide calculation and control capabilities, to support the operation of the entire computer device.

The internal memory provides a running environment for the computer program in the non-volatile storage medium. When the computer program is executed by the processor 401, the processor 401 may be enabled to perform any battery pack control method.

The network interface 403 is configured to perform network communication, for example send an allocated task. A person skilled in the art can understand that the structure shown in FIG. 5 is merely a block diagram of a part of the structure related to the solutions of the present application, and does not constitute a limitation on the computer device to which the solutions of the present application are applied. Specifically, the computer device may include more or fewer components than those shown in the figure, some components are combined, or a different component arrangement is used.

It should be understood that the processor 401 may be a central processing unit (CPU). Alternatively, the processor 401 may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

In an embodiment, the processor 401 is configured to run the computer program stored in the memory, to implement the steps of the battery pack control method.

An embodiment of the present application further provides a computer-readable storage medium. The computer-readable storage medium stores a computer program. The computer program includes program instructions. A processor executes the program instructions to implement any battery pack control method provided in the embodiments of the present application.

The computer-readable storage medium may be an internal storage unit of the computer device in the foregoing embodiment, for example, a hard disk drive or an internal memory of the computer device. Alternatively, the computer-readable storage medium may be an external storage device of the computer device, for example, a plug-in hard disk drive, a smart media card (SMC), a secure digital (SD) card, or a flash card on the computer device.

The foregoing descriptions are merely specific implementations of the present application, but are not intended to limit the protection scope of the present application. Any equivalent modification or replacement readily figured out by a person skilled in the art within the technical scope disclosed in the present application shall fall within the protection scope of the present application. Therefore, the protection scope of the present application shall be subject to the protection scope of the claims

What is claimed is:

1. A battery pack control method for controlling a plurality of battery packs in a multi-battery pack system, wherein the method comprises:
detecting real-time load power of the multi-battery pack system; and
when the real-time load power is less than a first power threshold, and at least two battery packs discharge in parallel, determining a target battery pack from the battery packs discharging in parallel, maintaining a discharge function of the target battery pack, and disabling a discharge function of another battery pack discharging in parallel other than the target battery pack.

2. The method according to claim 1, wherein after the detecting real-time load power of the multi-battery pack system, the method further comprises:
when it is detected that the real-time load power is greater than the first power threshold and less than a second power threshold, and the at least two battery packs discharge in parallel, starting timing;
when it is detected that the real-time load power is greater than or equal to the second power threshold, terminating timing; and
when duration of timing is greater than a preset duration threshold, determining the target battery pack from the battery packs discharging in parallel, maintaining the discharge function of the target battery pack, and disabling the discharge function of the another battery pack discharging in parallel other than the target battery pack, wherein
the first power threshold is less than the second power threshold.

3. The method according to claim 1, wherein after the detecting real-time load power of the multi-battery pack system, the method further comprises:
when the real-time load power is greater than a third power threshold, if a battery pack that does not discharge comprises a battery pack satisfying a preset parallel operation condition, enabling a discharge function of the battery pack satisfying the preset parallel operation condition, wherein the third power threshold is greater than or equal to a second power threshold.

4. The method according to claim 1, wherein the determining a target battery pack from the battery packs discharging in parallel comprises:
obtaining a state of charge of each battery pack discharging in parallel; and
determining a battery pack with a highest state of charge as the target battery pack.

5. The method according to claim 1, wherein the determining a target battery pack from the battery packs discharging in parallel comprises:
obtaining a battery capacity of each battery pack discharging in parallel; and
determining a battery pack with a highest battery capacity as the target battery pack.

6. The method according to claim 1, wherein the disabling a discharge function of another battery pack discharging in parallel other than the target battery pack comprises:
turning off a discharge switching transistor of the another battery pack discharging in parallel other than the target battery pack.

7. The method according to claim 1, wherein the detecting real-time load power of the multi-battery pack system comprises:
detecting real-time load power of each battery pack; and
determining the real-time load power of the multi-battery pack system based on the real-time load power of each battery pack.

8. An energy storage device, wherein the energy storage device comprises a battery pack, a processor, a memory, a computer program stored on the memory and executable by the processor, and a data bus configured to implement a connection and communication between the processor and the memory, wherein when the computer program is executed by the processor, the battery pack control method according to claim 1 is implemented.

9. An energy storage system, wherein the energy storage system comprises a controller and a plurality of battery packs, wherein
the controller is communicatively connected to the plurality of battery packs, and the controller is configured to perform the battery pack control method according to claim 1.

10. A storage medium for computer-readable storage, wherein the storage medium stores one or more programs, and the one or more programs are executable by one or more processors, to implement the battery pack control method according to claim 1.
